(19) United States
(12) Patent Application Publication
(10) Pub. No.: US 2025/0289322 A1
(43) Pub. Date: Sep. 18, 2025

(54) METHOD FOR TORQUE-BASED OPERATION OF AN INVERTER OF AN ELECTRIC DRIVE OF A VEHICLE, INVERTER, ELECTRIC DRIVE, VEHICLE, COMPUTER PROGRAM AND/OR COMPUTER-READABLE MEDIUM

(71) Applicant: ZF CV Systems Global GmbH, Bern (CH)

(72) Inventors: Daniel Rasch, Sarstedt (DE); Thomas Kattenberg, Vechelde (DE)

(21) Appl. No.: 19/227,125

(22) Filed: Jun. 3, 2025

Related U.S. Application Data
(63) Continuation of application No. PCT/EP2023/083318, filed on Nov. 28, 2023.

(30) Foreign Application Priority Data
Dec. 7, 2022 (DE) 10 2022 132 508.3

(51) Int. Cl. B60L 15/20; B60L 7/10; H02P 3/14

(52) U.S. Cl. CPC B60L 15/2009; B60L 7/10; H02P 3/14; B60L 2240/423

(57) ABSTRACT

A method is for torque-based operation of an inverter of an electric drive of a vehicle, in particular a commercial vehicle. The electric drive is set up for regenerative braking. A control unit is connected to the inverter and different from the inverter and is for controlling a friction brake device and/or the electric drive. The method includes: measuring an actual rpm of the electric drive via the inverter; ascertaining a rpm limit determined based on a target rpm for a wheel which is able to be driven by the electric drive via the controller; determining an updated rpm limit as a function of the rpm limit and the actual rpm via the controller; and, operating the inverter at a reduced torque based on the updated rpm limit.

### CROSS-REFERENCE TO RELATED APPLICATIONS

This application is a continuation application of international patent application PCT/EP2023/083318, filed Nov. 28, 2023, designating the United States and claiming priority from German application 10 2022 132 508.3, filed Dec. 7, 2022, and the entire content of both applications is incorporated herein by reference.

### TECHNICAL FIELD

The disclosure relates to a method for torque-based operation of an inverter of an electric drive of a vehicle set up for regenerative braking, in particular a commercial vehicle, with a controller that is different from the inverter and that is connected to the inverter for controlling a friction brake device and/or the electric drive. The disclosure also relates to an inverter for an electric drive of a vehicle, in particular a commercial vehicle, an electric drive, a vehicle, in particular a commercial vehicle, and a computer program and/or a computer-readable medium.

### BACKGROUND

In other words, the disclosure relates in particular to trucks and trailers optionally with an electronically controlled braking system (EBS or TEBS) and with at least one electrically driven axle with an electric drive (eDrive-central drive or wheel-specific drive), which can be operated as a wear-free continuous brake and thus enables braking energy to be recovered in the form of electrical energy during deceleration (recuperation). The electric drive typically includes a drive controller, also known as an eDrive ECU, an inverter with an internal inverter controller, an electric machine and an optional switchable gearbox.

To ensure stability, the acting torque and the slip (driving slip and braking slip) must be limited in certain situations on the driven axle or the driven axles. This requires coordination between the electric drive and the braking system, which usually monitors and regulates driving stability, for example through an anti-lock braking system (ABS) and electronic stability control (ESC), including active roll over protection (ARP) and yaw rate control.

In stability-critical and slip-critical deceleration situations, the electric drive is deactivated by the friction brake controller in accordance with the prior art and only friction brakes or the friction brake device are used for control. This is due to the fact that classic continuous brakes (so-called retarders) cannot be controlled precisely and dynamically enough due to their dynamics.

However, the electric drive has the necessary dynamics and precision, so that the potential in terms of recuperation and, in particular, in terms of improving braking performance and stability is not exhausted.

If the electric drive is operated with slip-control in certain drive and/or braking cases, close coordination between the electric drive and the braking system and the stability control thereof is necessary. It must be ensured that the achieved slip values and torques are high enough to achieve recuperation, an achievable deceleration during braking and/or propulsion during acceleration, but at the same time are below a maximum value critical to stability, in particular in order to achieve sufficient lateral control. The overall slip behavior is strongly dependent on the friction pairing of the tire and the surface, including dynamic changes in the surface or the surface coefficient of friction, and the load distribution or the static and dynamic axle load distribution.

DE 10 2016 208 766 A1 discloses a method for operating a motor vehicle, wherein an automated driving operation is carried out, wherein a first braking device is used for the automated deceleration of the motor vehicle, wherein at least one operating parameter of the motor vehicle is recorded during the automated driving process, wherein it is checked whether the at least one operating parameter fulfils a predetermined test criterion, and wherein the motor vehicle is automatically decelerated with a second braking device if the at least one operating parameter does not meet the test criterion.

EP 3 299 230 A1 discloses an integrated brake control section that generates a target braking force and a target wheel speed equivalent value of each electric braking device as target values and transmits the target braking force and the target wheel speed equivalent value to a target value transmitter. An electric brake control device of any electric braking device contains a brake force controller that controls an electric motor according to the target braking force, a wheel speed controller that controls the electric motor in accordance with the target wheel speed equivalent value, and a control switch. The control switch switches between using the brake force controller and using the wheel speed controller in accordance with a predetermined condition.

Slip control via the friction brake device, also known as a service brake, or via one or more electric drives is known from the prior art.

An advantage of controlling via the friction brake device is that the friction brake device has essential information relevant to driving stability and can perform braking interventions in a coordinated manner. For example, in the case of traction control, ASR, on a road surface with a different coefficients of friction per wheel (u-split condition or MU split condition or MU split scenario), control can be carried out by holding the spinning wheel at a lower coefficient of friction via brake intervention.

In contrast, especially in the case of wheel-specific drives, control via the electric drive offers the advantage that it can carry out fast and accurate rpm and/or torque control internally. If the control is carried out via the braking system and thus on a separate controller, this always includes an additional communication path, usually via a vehicle bus, for example a CAN-BUS, with corresponding dead times and delay.

EP 3 995 370 A1 proposes the application of speed limits for slip control. Here the wheel-related speed limits, which are calculated by the “Motion Management System”, are transmitted to the “Motion Support System”. There, the torque is limited according to the current rpm and the speed limits. The torque is transmitted as a control signal and physically converted.

A state-of-the-art inverter has the possibility that a permissible maximum or minimum rpm, that is, a rpm limit, can be dynamically specified via a connected controller in parallel with target torques. Even before this rpm limit is reached, the inverter reduces the torque thereof internally (derating) so that the rpm limit cannot be exceeded in the stationary case. This rpm-dependent or speed-dependent torque reduction is typically used to limit the maximum speed of a vehicle.

The advantage of slip control in particular is that in the event of slippage, a very fast reaction can be made on the inverter on the basis of a resolver signal that is directly connected to the inverter. No other controllers or communication links, such as via a fieldbus (CAN), are integrated into the control loop.

On the other hand, there is the disadvantage that the inverter only knows the actual rpm of the electric drive based on the resolver signal, but not the wheel rpm, especially in the case of central drives with differentials. In the case of central drives in a MU split scenario, the speed limit must be set appropriately by another controller based on the wheel rpms in order to be able to control the wheel on one side with a lower coefficient of friction (low-u side). In addition, the speed-dependent torque limitation (derating) implemented on the inverter reduces the torque even before the received speed limit is reached. This means that there is always a certain offset between the actual rpm and a target rpm. This means that the inverter is not operated optimally.

### SUMMARY

It is an object of the disclosure to enhance the prior art. In an elaboration of the disclosure, the object is achieved to provide an improved operating strategy for operating an inverter of an electric drive.

The object is, for example, achieved by various methods, inverters, electric drives, vehicles, computer programs, and non-transitory computer readable mediums according to the disclosure.

According to the disclosure, a method is provided for torque-based operation of an inverter of an electric drive of a vehicle set up for regenerative braking, in particular a commercial vehicle, with a controller that is different from the inverter that is connected to the inverter for controlling a friction brake device and/or the electric drive. The method includes: detection of an actual rpm of the electric drive by the inverter; ascertaining a rpm limit determined by the controller on the basis of a target rpm for a wheel that can be driven by the electric drive; determination of an adjusted rpm limit depending on the rpm limit and the actual rpm by the controller; and operating the inverter with a reduced torque based on the adjusted rpm limit.

The vehicle, in particular the commercial vehicle, is hereinafter referred to as the vehicle. In other words, a distributed slip control between a controller and the inverter is proposed, based on a suitable amendment of the rpm limit. It was discovered that the actual rpm of the inverter is not set in such a way that the wheel reaches the target rpm due to the principle of the prior art, since there is always a transferable torque and thus an offset or a difference. By using feedback of the rpms, the rpm limit can be adjusted in such a way that the inverter can be operated effectively.

The actual rpm of the electric drive can be detected by the inverter, for example in the case of a wheel-specific drive via the inverter or the resolver signal thereof in order to exploit the dynamic advantages of the inverter.

The target rpm can define the rpm of the wheel to be controlled. In particular, determining the target rpm can be based on a slip limit. The slip limit can describe a maximum positive slip in the driving case or a maximum negative slip in terms of magnitude in the braking case. The target rpm can be ascertained on the basis of an actual vehicle speed and an actual wheel rpm and can therefore be effectively ascertained by the controller. The adjusted rpm limit can be defined in such a way that the wheel reaches the target rpm.

The adjusted rpm limit can be ascertained in order to operate the inverter with the reduced torque. The rpm limit can be adjusted in such a way that the target rpm is reached despite a reduction of the torque by derating to the reduced torque in accordance with the adjusted rpm limit. The reduced torque can be a reduced torque compared to a target torque. By adhering to defined specifications for driving and/or decelerating via the slip limit or the target rpm, driving stability is guaranteed and the target rpm on the wheel is achieved. At the same time, the high control quality and dynamics of an inverter-internal controller are exploited in the best possible way. In the case of a central drive, that is, when several wheels are driven by the inverter, it may be necessary to adjust the speed limit based on the rpm of the wheel that is slipping more or more strongly, which is done by the controller.

According to various embodiments, the reduced torque is determined depending on a difference between the adjusted rpm limit and the actual rpm of the electric drive. This means that the adjusted rpm limit will define the derating instead of the original rpm limit. This allows the target rpm to be achieved and the offset between the target rpm and the actual rpm of the wheel can be reduced or minimized. Optionally, the reduced torque can be linearly dependent on a rpm difference between the actual rpm and the adjusted rpm limit in order to define a dependence to be effectively implemented in the inverter.

According to various embodiments, the adjusted rpm limit is determined in such a way that the actual rpm of the inverter corresponds to the rpm limit. This allows the inverter to reach the rpm limit and thus the target rpm of the wheel can be set.

According to various embodiments, the rpm limit is ascertained taking into account an actual wheel rpm related to the wheel and an actual vehicle speed of the vehicle, in particular the commercial vehicle. Wheel-specific control can thus be enabled. The rpm limit can be determined on the basis of the actual vehicle speed and the actual wheel rpm, taking into account a slip limit that is to be observed.

According to various embodiments, the adjusted speed limit is determined in such a way that the speed of a wheel of the vehicle, in particular a commercial vehicle, which slips more than another wheel, corresponds to the target rpm. The wheel that slips more strongly and the other wheel can be driven by the inverter (central drive). This makes it possible to ensure that the wheels maintain a slip limit, thus achieving effective and safe operation of the vehicle, especially the commercial vehicle. It is advantageous that the adjusted rpm limit is determined by the friction brake controller, as the friction brake controller knows the wheel rpms and/or wheel speeds.

According to various embodiments, the reduced torque is a driving torque or a braking torque. This allows the inverter to be operated in such a way as to accelerate the wheel according to the driving torque or decelerate it according to the braking torque.

According to various embodiments, the method involves the following step: transmitting the reduced torque from the inverter to a friction brake controller. The reduced torque can be transmitted to the friction brake controller in order to be able to apply the brakes taking into account the reduced torque. For example, the reduced torque and a friction braking torque can generate respective deceleration or braking torque components based on a braking requirement.

According to various embodiments, the controller is a friction brake controller or a drive controller. The friction brake device can provide essential information for control, such as the target rpm. The drive controller can define specifications regarding the target torque and/or the derating for the inverter.

According to another aspect of the disclosure, an inverter is provided for an electric drive of a vehicle, in particular a commercial vehicle. The inverter is set up to perform the method described here. The inverter may be set up to carry out steps of the method described as optional and/or advantageous in order to achieve an appropriate technical effect.

According to another aspect of the disclosure, an electric drive is provided for a vehicle, in particular a commercial vehicle. The electric drive has the inverter described here. The electric drive and/or inverter may be set up to carry out steps of the method described as optional and/or advantageous in order to achieve an appropriate technical effect.

According to another aspect of the disclosure, a vehicle, in particular a commercial vehicle, is provided. The vehicle has the inverter or electric drive described here. The vehicle, inverter and/or electric drive may be set up to carry out steps of the method described as optional and/or advantageous in order to achieve an appropriate technical effect.

According to another aspect of the disclosure, a computer program and/or computer-readable medium is provided. The computer program and/or computer-readable medium contains commands that, when executed by a computer, cause the computer to carry out the method described here and/or the steps of the method described here. The computer program and/or computer-readable medium may contain commands to perform steps of the method described as optional and/or advantageous in order to achieve an appropriate technical effect.

### BRIEF DESCRIPTION OF DRAWINGS

The invention will now be described with reference to the drawings wherein:

FIG. 1 shows a schematic representation of an overview of a vehicle, in particular a commercial vehicle, according to an embodiment of the disclosure;

FIG. 2 shows a schematic representation of a calculation sequence in accordance with the prior art;

FIG. 3 shows a schematic representation of a calculation sequence according to a method according to an embodiment of the disclosure;

FIG. 4 shows a schematic representation of speeds as a function of time to illustrate an effect of a method according to an embodiment of the disclosure;

FIG. 5 shows a schematic representation of a dependence of torque and an actual rpm of an electric drive according to an embodiment of the disclosure;

FIG. 6 shows a schematic representation of a dependence of torque and an actual rpm of an electric drive according to an embodiment of the disclosure;

FIG. 7 shows a schematic representation of a dependence between slip and coefficient of friction;

FIG. 8 shows a schematic representation of several alternative topologies of a vehicle, in particular a commercial vehicle, for carrying out a method according to an embodiment of the disclosure; and,

FIG. 9 shows a schematic representation of a method according to an embodiment of the disclosure.

### DETAILED DESCRIPTION

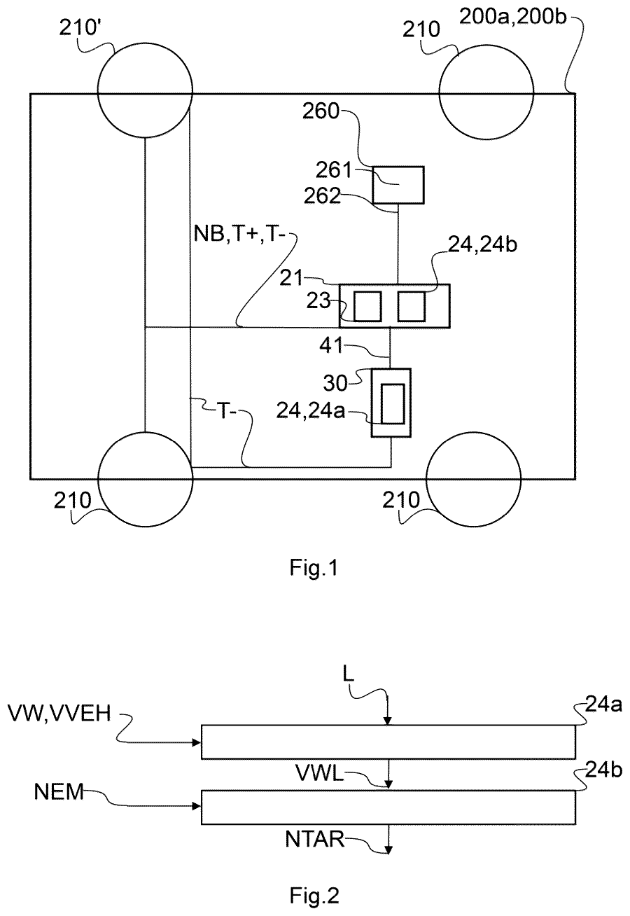

FIG. 1 shows a schematic representation of an overview of a vehicle 200a, in particular a commercial vehicle 200b, according to an embodiment of the disclosure.

The vehicle 200a, in particular the commercial vehicle 200b, is hereinafter referred to as the vehicle 200a, 200b. The vehicle 200a, 200b is a land vehicle and, for example, a truck, a bus, a trailer and/or a multi-unit vehicle.

The vehicle 200a, 200b has an electric drive 21. The vehicle 200a, 200b also has a friction brake device 30. The friction brake device 30 is an electric braking system or an electronically controlled brake system. In an embodiment that is not shown, the friction brake device 30 is a pneumatic and/or hydraulic braking system. The friction brake device 30 has a friction brake controller 24a.

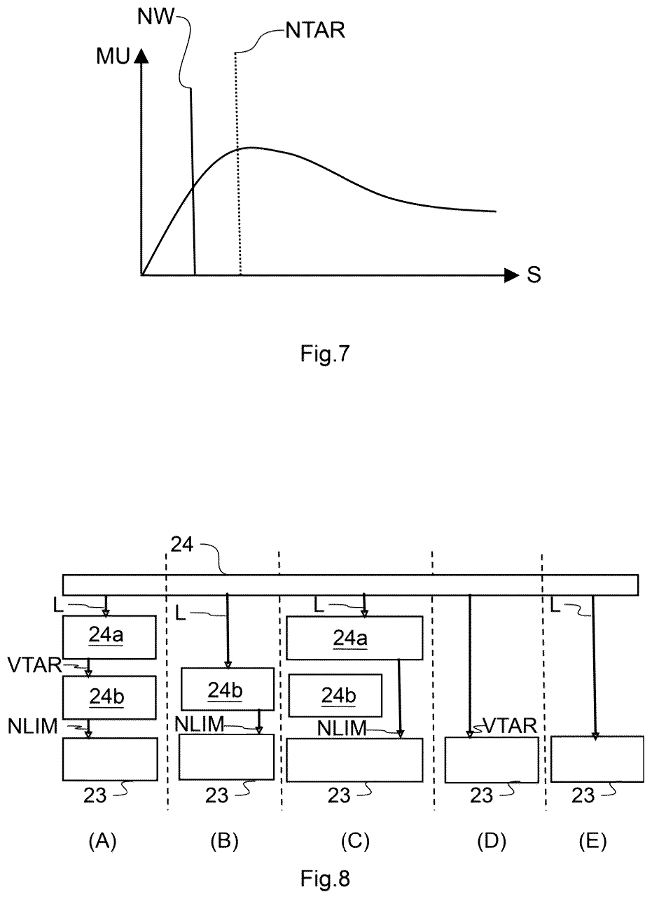

The vehicle 200a, 200b according to FIG. 1 has several wheels 210, 210′. The wheels 210 are arranged on a roadway. A torque T transmitted by the road surface and effected by the electric drive 21 and the friction brake device 30 can act on the wheels 210 as a driving torque T+ or a braking torque T−. In particular, the roadway may be subject to local changes. For example, the roadway can have different surfaces in different places and thus lead to different coefficients of friction MU between the roadway and the wheels 210, 210′ (see also FIG. 7). A different slip S can occur on the wheels 210, 210′. The slip S can be calculated from an actual wheel rpm VW of the respective wheel 210, 210′ and an actual vehicle speed VVEH. The wheels 210, 210′ can have a different slip S, so that one of the wheels 210 can be described as a more strongly slipping wheel 210 than the other wheels 210′.

The electric drive 21 is set up for regenerative braking NB. The braking torque T− can act and the mechanical energy of the wheels 210, 210′ can be converted into electrical energy 262. The electrical energy 262 can be applied to an energy storage device 260 of the vehicle 200a, 200b in order to increase the state of charge 261 thereof.

The electric drive 21 is set up to generate the driving torque T+ or the braking torque T−, which can lead to acceleration or deceleration of the vehicle 200a, 200b or one of the wheels 210 ‘210’. The friction brake device 30 is set up to apply a braking torque T− to one or more of the wheels 210, 210′.

The electric drive 21 is set up as a so-called central drive to apply a torque T to one or more wheels 210, 210′ of an axle (not shown). In another embodiment (not shown), the electric drive 21 is set up to apply a torque T to exactly one wheel 210, 210′.

The dynamics of each of the wheels 210, 210′ can be characterized by a measurable wheel acceleration or wheel deceleration and/or a change in the wheel acceleration over time. The wheel deceleration and/or the change of the wheel acceleration against time can be detected by measured values of a wheel rpm sensor (not shown) and/or by control information of the electric drive 21.

The electric drive 21 contains an inverter 23 and a drive controller 24b. The drive controller 24b can be referred to as an eDrive ECU. The drive controller 24b is set up to operate the inverter 23 according to control specifications and to read control information from the inverter 23. The inverter 23 can detect an actual rpm NEM of the electric drive 21 and transmit it to the drive controller 24b. The drive controller 24b can specify a target torque TT and an adjusted rpm limit NLIM for the inverter 23. The adjusted rpm limit NLIM can include a lower limit NLIM− and/or an upper limit NLIM+. The inverter 23 is set up to set the actual rpm NEM based on the specifications, wherein the inverter 23 can apply a reduced torque TR before and/or when the rpm limit NTAR and/or an adjusted rpm limit NLIM is reached. The actual rpm NEM of the electric drive 21 detected by the inverter 23 translates directly into the actual wheel rpm VW, VW′ in the case of a wheel-specific drive or indirectly via a gearbox in the case of a central drive.

The drive controller 24b and the friction brake controller 24a are controllers 24 of the vehicle 200a, 200b. The controllers 24 are different from the inverter 23 and from an inverter internal controller (not shown). Each of the controllers 24, that is, the drive controller 24b and the friction brake controller 24a, are set up to communicate with the inverter 23 to operate the inverter 23.

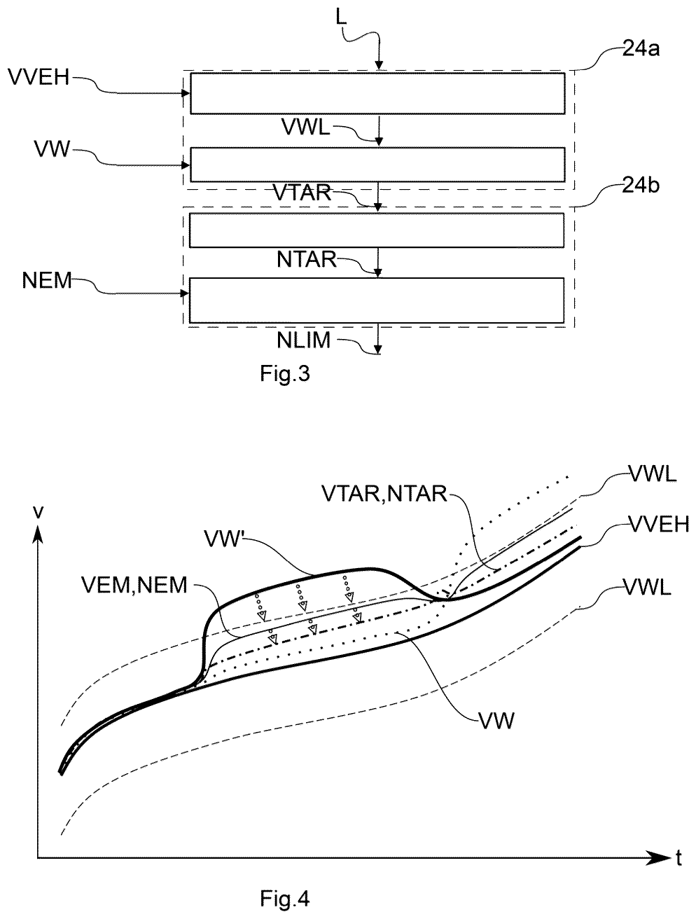

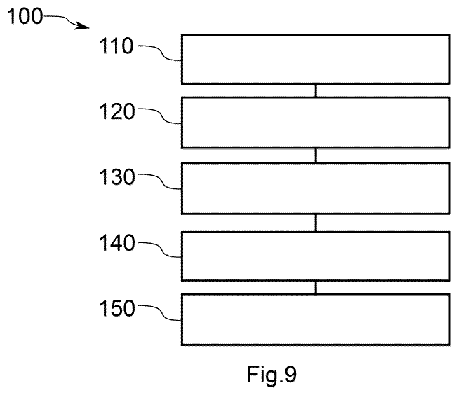

The vehicle 200a, 200b or the inverter 23 and/or the controllers 24 are set up to carry out the method 100 described with reference to FIG. 9. For this purpose, the controller 24 can determine the adjusted rpm limit NLIM as described with reference to FIGS. 3 to 6 in order to operate the inverter 23 accordingly. Communication between the inverter 23 and the controller or controllers 24 or an architecture as described with reference to FIG. 8 may be provided.

FIG. 2 shows a schematic representation of a calculation procedure according to the prior art. FIG. 2 illustrates a friction brake controller 24a and a drive controller 24b. FIG. 2 is described with reference to the nomenclature or signs according to FIG. 1.

According to FIG. 2, the friction brake controller 24a detects a slip limit L, an actual wheel rpm VW and an actual vehicle speed VVEH. From this, the friction brake controller 24a determines a target rpm VWL for a wheel 210, 210′, that is, a wheel-related speed v. For example, the target rpm VWL for the wheel 210, 210′ is calculated by the equation VWL=VVEH/(1−L) for driving and by the equation VWL=VVEH×(1−L) for braking.

The friction brake controller 24a transmits the target rpm VWL for the wheel 210, 210′ to the drive controller 24b. The drive controller 24b detects the actual rpm NEM of the electric drive 21 via the inverter 23 or the resolver and calculates a rpm limit NTAR for operating the inverter 23. The rpm limit NTAR can be understood as or can be converted into an inverter-related speed v. The inverter 23 is operated according to the rpm limit NTAR.

FIG. 3 shows a schematic representation of a calculation sequence in accordance with a method 100 according to an embodiment of the disclosure. FIG. 3 illustrates a friction brake controller 24a and a drive controller 24b. FIG. 3 is described with reference to FIG. 1 and the description thereof.

According to FIG. 3, the friction brake controller 24a detects a slip limit L and an actual vehicle speed VVEH in a first step and determines the target rpm VWL for a wheel 210, 210′ as described in FIG. 2. In a second step, the friction brake controller 24a detects the actual wheel rpm VW and ascertains a target speed VTAR for the electric drive 21, for example by the equation VTAR=max (VWL+½×min (VW_links−VWL; VW_rechts−VWL), VVEH+VOFFS) for driving with an offset speed VOFFS, an actual wheel rpm VW_links of a left wheel 210, 210′, an actual wheel rpm VW_rechts of a right wheel 210, 210, and the minimum function min( ) The target speed VTAR is a wheel-related speed v.

The friction brake controller 24a transmits the target speed VTAR to the drive controller 24b. In a first step, the drive controller 24b ascertains a rpm limit NTAR related to the inverter 23 based on the target speed VTAR. In a second step, the drive controller 24b detects the actual rpm NEM of the electric drive 21 and calculates an adjusted rpm limit NLIM for operating the inverter 23 taking into account the rpm limit NTAR.

According to a variant (see (A) in FIG. 8), the friction brake controller 24a can calculate the target speed VTAR, taking into account the actual wheel rpm VW_links of the left wheel 210, 210′ and the actual wheel rpm VW_rechts of the right wheel 210, 210 and the slip limit L. The friction brake controller 24a sends the target speed VTAR to the drive controller 24b. From this the drive controller 24b calculates the adjusted rpm limit NLIM in such a way that the actual rpm NEM of the electric drive 21 reaches the adjusted rpm limit NLIM.

According to another variant, which is particularly suitable for a central drive (see also (A) in FIG. 8), the friction brake controller 24a can calculate the target speed VTAR taking into account the slip limit L. The friction brake controller 24a reads the actual wheel rpm VW_links of the left wheel 210, 210′ and the actual wheel rpm VW_rechts of the right wheel 210, 210 and calculates an axis-related adjusted speed limit VLIM from these, so that the actual wheel rpms VW_links, VW_rechts comply with and/or reach the target speed VTAR. The amendment is based on the wheel rpms. The friction brake controller 24a sends the adjusted speed limit VLIM to the drive controller 24b. The drive controller 24b converts the adjusted speed limit VLIM to the adjusted rpm limit NLIM. The drive controller 24b sends the adjusted rpm limit NLIM to the inverter 23, wherein no adjustment is carried out by the drive controller 24b.

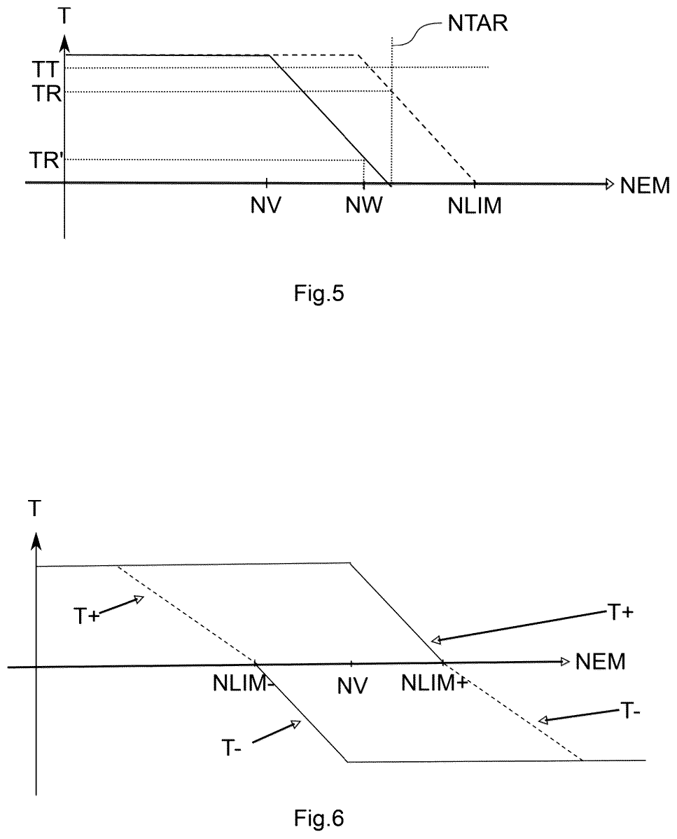

The adjusted rpm limit NLIM can be understood as or converted into an inverter-related speed v. For example, the adjusted rpm limit NLIM is calculated by the equation NLIM=NTAR+K×int(NTAR−NEM) dt, where K is an optional constant gain factor and int ( . . . ) dt is an integral over time t. The integration limits can depend on the maximum or minimum torque T. The adjusted rpm limit NLIM is calculated in such a way that the rpm limit NTAR is only shifted to the extent that the maximum of the speed difference-dependent derating curve (see FIGS. 5 and 6) is at the level of the rpm limit. For example, the entire torque can still be released in the speed limit if necessary, for example for a wheel 210 on a roadway with a high coefficient of friction MU.

The inverter 23 is operated using the adjusted rpm limit NLIM. Anti-windup conditions can be inserted for the integrating part so that the integrator does not integrate beyond plausible values. The integration limits can depend on the maximum or minimum torque T.

FIG. 4 shows a schematic representation of speeds v as a function of time t to illustrate an effect of a method 100 according to an embodiment of the disclosure. FIG. 4 is described with reference to FIGS. 1 and 3.

The lower curve of FIG. 4 shows the actual vehicle speed VVEH with a thick solid line. The vehicle 200a, 200b is accelerating. The actual vehicle speed VVEH is increasing.

The target rpms VWL for a wheel 210, 210′ are shown with two dashed lines. For example, the target rpms VWL for the wheel 210, 210′ result from the slip limit L and the actual vehicle speed VVEH, as described with reference to FIGS. 2 and 3, wherein the lower of the two curves of the target rpms VWL for the wheel 210, 210′ illustrates the braking case and the upper of the two curves of the target rpms VWL for the wheel 210, 210′ illustrates the driving case.

The actual wheel rpm VW, VW′ should be within the two curves of the target rpm VWL for the wheel 210, 210′ in order to enable stable, reliable and effective operation of the vehicle 200a, 200b. that is, at all times t, the actual wheel rpm VW, VW′ should be between the target rpms VWL for the wheel 210, 210′.

A dotted line shows a wheel rpm VW of an initially less strongly slipping wheel 210. The dotted line with the wheel rpm VW is initially within the target rpms VWL for the wheel 210, 210.

With a thick solid line (upper curve) a wheel rpm VW′ of a more strongly slipping wheel 210 is shown. The wheel rpm initially exceeds the target rpm VWL for the wheel 210, 210′, is therefore too high and must be regulated.

A target speed VTAR as described with reference to FIG. 3 is drawn with a dot-dashed line. The target speed VTAR can be converted to the rpm limit NTAR. An actual speed VEM of the electric drive 21 is drawn with a thin solid line. The actual speed VEM of the electric drive 21 can be converted into the actual rpm NEM of the electric drive 21.

Since the wheel rpm VW′ exceeds the target rpms VWL for the wheel 210, 210′, the actual speed VEM of the electric drive 21 must be readjusted in order to drive the more strongly slipping wheel 210′ less and/or decelerate it and thus to regulate the wheel rpm VW′ in a range between the two target rpms VWL for the wheel 210, 210′. To do this, the actual speed VEM of the electric drive 21 is reduced to the target speed VTAR, as indicated by arrows. As also indicated by arrows, the wheel rpm VW is also regulated to a value between the target rpms VWL for the wheel 210, 210′. FIG. 4 thus represents wheel-specific control. For this purpose, the adjusted rpm limit NLIM is determined taking into account the actual rpm NEM in order to operate the inverter 23 with a reduced torque TR in such a way that an offset between the wheel rpm VW′ and the target speed VTAR is reduced or prevented. This makes it possible for only the stronger slipping wheel 210′, for example the faster wheel 210′, to be brought to the target rpm VWL, while the less strongly slipping wheel 210 can have a larger offset.

For the calculation of the rpm difference between the actual wheel rpm VW and the target rpm VWL, the actual wheel rpm VW of the wheel 210 with the larger slip S can be used in central drives in order to be able to adjust the wheel 210′ to a low coefficient of friction in u-split situations. For centrally driven axles, the friction brake system 30 monitors the realization of the desired wheel-specific or side-specific target slip and can have a stabilizing effect through braking interventions (see FIG. 6). In the driving case an additional braking torque T− can be generated on the low-μ side in order to increase the total transferable driving force on the high-μ side. Alternatively or additionally, the electric drive 21 can request targeted braking interventions. In the braking case, an additional braking torque T− can be built up on the high-μ side by the friction brake system 30.

FIG. 5 shows a schematic representation of a dependence on torque T and an actual rpm NEM of an electric drive 21 according to an embodiment of the disclosure. FIG. 5 is described with reference to FIGS. 1, 3 and 4.

It is assumed that a target torque TT is required. The target torque TT is shown in FIG. 5 by a horizontal line.

FIG. 5 also illustrates a vehicle rpm NV. The vehicle rpm NV is defined as the rpm of the electric drive 21 under the assumption that the vehicle 200a, 200b is driving S without slippage.

In FIG. 5, the solid line represents a derating, that is, a rpm-dependent reduction of the torque T implemented in the inverter 23 as a function of the actual rpm NEM of the electric drive 21 in accordance with the prior art. The torque T is reduced from a reference torque in such a way that the torque T becomes zero at an actual rpm NEM equal to the rpm limit NTAR. Since there is no longer any torque T at the rpm limit NTAR, the rpm limit NTAR cannot be reached in the stationary case. Instead, the electric drive 21 is operated with a reference rpm NW, which is achieved without adjusting the rpm limit NTAR, and with a reduced torque TR′ resulting from the derating, the reference rpm NW and the rpm limit NTAR.

The dashed line in FIG. 5 shows a torque curve resulting from a derating that is set with regard to the adjusted torque NLIM. The derating of the inverter 23, that is, the (negative) increase in the rpm-dependent torque curve, is known. This allows the adjusted rpm limit NLIM to be selected in such a way that the inverter 23 sets the rpm limit NTAR at a reduced torque TR as the actual rpm NEM in order to achieve the target rpm VWL for the wheel 210, 210′.

FIG. 6 shows a schematic representation of a dependence of torque T and an actual rpm NEM of an electric drive 21 according to an embodiment of the disclosure. FIG. 6 is described with reference to FIGS. 1 and 3 to 5.

The rises of the curves shown describe the derating. During the acceleration of the vehicle 200a, 200b, the torque T is first limited by the derating curve of the driving torque T+ (solid line). If the adjusted rpm limit NLIM is exceeded for driving, the drive shaft is actively braked by the derating curve T− by a negative torque T− (dashed line).

In the event of braking, the negative torque is initially limited by the derating curve of the braking torque T− (solid line). If the adjusted rpm limit NLIM is exceeded in the event of braking, the drive shaft is actively accelerated by the derating curve by a positive torque T+ (dashed line).

The derating can be adjusted depending on the use case, falling below a lower limit NLIM and/or exceeding an upper limit NLIM+. Such an adjustment is shown as different slopes of the curves shown. Alternatively or additionally, any functions (for example nonlinear or non-continuous) and/or look-up tables can be used to implement derating. The torque TR reduced by derating is thus a driving torque T+ or a braking torque T−, depending on the application and x-axis section.

FIG. 7 shows a schematic representation of a dependence between slip S and coefficient of friction MU. The coefficient of friction MU is defined for a wheel 210, 210′ and a ground contacting the wheel 210, 210′. Depending on the coefficient of friction MU, a slip S illustrated by FIG. 7 can be applied as a driving slip or as a braking slip. In most cases, the dependence between slip S and coefficient of friction MU has a unimodal profile with a maximum, that is, a slip S corresponding to the maximum coefficient of friction, which is present at a certain coefficient of friction MU. The slip S which corresponds to the maximum coefficient of friction enables the best possible use of recuperation, the best possible acceleration and/or deceleration.

A slip S that is achieved when the electric drive 21 is operated with the reference rpm NW described with reference to FIG. 5 is marked by a left vertical line. A slip S that occurs when the electric drive 21 is operated with the adjusted rpm limit NLIM is marked by a right vertical line.

FIG. 7 thus illustrates that the electric drive 21 is not operated at an optimal operating point with the reference rpm NW. Adjusting the actual rpm NEM to the adjusted rpm limit NLIM achieves improved operation of the electric drive 21.

FIG. 8 shows a schematic representation of several alternative topologies of a vehicle 200a, in particular a commercial vehicle 200b, for carrying out a method 100 according to an embodiment of the disclosure.

FIG. 8 shows five different alternatives, which are identified by the letters (A), (B), (C), (D) and (E) and separated from each other by a vertical dashed line.

(A) in FIG. 8 shows the embodiment described with reference to FIG. 3. The slip limit L is ascertained by the controller 24 and transmitted to the friction brake controller 24a if the controller 24 is different from the friction brake controller 24a. Otherwise, the transmission of the slip limit L may be omitted. The friction brake controller 24a receives the slip limit L and determines the target speed VTAR for the electric drive 21. The target speed VTAR can be calculated taking into account the actual wheel rpm VW_links of the left wheel 210, 210′ and the actual wheel rpm VW_rechts of the right wheel 210, 210. Optionally, an adjusted speed limit VLIM is calculated (see FIG. 3). The friction brake controller 24a transmits the target speed VTAR and optionally the adjusted speed limit VLIM to the drive controller 24b. The drive controller 24b receives the target speed VTAR and optionally the adjusted speed limit VLIM and ascertains the adjusted rpm limit NLIM. The drive controller 24b initiates the operation of the inverter 23 using the adjusted rpm limit NLIM.

In (B) in FIG. 8, the slip limit L is ascertained by the controller 24 and transmitted to the drive controller 24b if the controller 24 is different from the drive controller 24b. Otherwise, the transmission of the slip limit L may be omitted. The drive controller 24b receives the slip limit L and ascertains the adjusted rpm limit NLIM. The drive controller 24b initiates the operation of the inverter 23 using the adjusted rpm limit NLIM.

In (C) in FIG. 8, the slip limit L is ascertained by the controller 24 and transmitted to the friction brake controller 24a if the controller 24 is different from the friction brake controller 24a. Otherwise, the transmission of the slip limit L may be omitted. The friction brake controller 24a receives the slip limit L and ascertains the adjusted rpm limit NLIM. The friction brake controller 24a initiates the operation of the inverter 23 using the adjusted rpm limit NLIM.

In (D) in FIG. 8, the slip limit L and the target speed VTAR for the electric drive 21 are ascertained by the controller 24. The controller 24 transmits the target speed VTAR to the inverter 23, which itself ascertains the adjusted rpm limit NLIM.

In (E) in FIG. 8, the slip limit L is ascertained by the controller 24. The controller 24 transmits the slip limit L to the inverter 23, which itself ascertains the adjusted rpm limit NLIM.

FIG. 9 shows a schematic representation of a method 100 according to an embodiment of the disclosure. The method 100 is a method 100 for the torque-based operation of an inverter 23 of an electric drive 21 set up for regenerative braking NB of a vehicle 200a, in particular a commercial vehicle 200b, with a controller 24 that is different from the inverter 23, that is connected to the inverter 23 and that is for controlling a friction brake device 30 and/or the electric drive 21. Such a vehicle 200a, 200b is described with reference to FIG. 1. FIG. 9 is described with reference to FIGS. 1 to 8.

The method 100 includes: detecting 110 an actual rpm NEM of the electric drive 21 by the inverter 23.

The controller 24 ascertains 120 a rpm limit NTAR determined on the basis of a target rpm VWL for a wheel 210 that can be driven by the electric drive 21. Ascertaining 120 the rpm limit NTAR is carried out taking into account an actual wheel rpm VW related to the wheel 310 and an actual vehicle speed VVEH of the vehicle 200a or the commercial vehicle 200b.

A determination 130 of an adjusted rpm limit NLIM as a function of the rpm limit NTAR and the actual rpm NEM is carried out by the controller 24. The adjusted rpm limit NLIM is determined in such a way that the actual rpm NEM of the electric drive 21 corresponds to the rpm limit NTAR. The adjusted rpm limit NLIM is determined in such a way that the speed of a wheel 210′ of the vehicle 200a, in particular a commercial vehicle 200b, which is slipping more strongly than another wheel 210, corresponds to the target rpm VWL.

The inverter 23 is operated 140 with a reduced torque TR based on the adjusted rpm limit NLIM. The reduced torque TR is determined depending on a difference between the adjusted rpm limit NLIM and the actual rpm NEM of the electric drive 21. The reduced torque TR is a driving torque T+ or a braking torque T−.

The reduced torque TR is transmitted 150 from the inverter 23 to a friction brake controller 24a.

It is understood that the foregoing description is that of the preferred embodiments of the invention and that various changes and modifications may be made thereto without departing from the spirit and scope of the invention as defined in the appended claims.

Reference signs (part of the description)

| | |
|---|---|
| 21 | electric drive |
| 23 | inverter |
| 24 | controller |
| 24a | friction brake controller |
| 24b | drive controller |
| 30 | friction brake device |
| 100 | method |
| 110 | detect |
| 120 | ascertain |
| 130 | determine |
| 140 | operate |
| 150 | transmit |
| 200a | vehicle |
| 200b | commercial vehicle |
| 210 | wheel |
| 210′ | wheel |
| 260 | energy storage device |
| 261 | state of charge |
| 262 | electrical energy |
| L | slip limit |
| MU | coefficient of friction |
| NB | regenerative braking |
| NEM | actual rpm of the electric drive |
| NLIM | adjusted rpm limit |
| NLIM− | limit of the adjusted rpm limit |
| NLIM+ | limit of the adjusted rpm limit |
| NTAR | rpm limit |
| NW | reference rpm |
| NV | vehicle rpm |
| S | slip |
| t | time |
| TR | reduced torque |
| TR′ | reduced torque |
| T | torque |
| T+ | driving torque, positive torque |
| T− | braking torque, negative torque |
| TT | target torque |
| v | speed |
| VEM | actual speed of the electric drive |
| VLIM | adjusted speed limit |
| VW | actual wheel rpm |
| VW′ | actual wheel rpm |
| VWL | target rpm for a wheel |
| VTAR | target speed for the electric drive |
| VVEH | actual vehicle speed |

1. A method for torque-based operation of an inverter of an electric drive of a vehicle set up for regenerative braking with a controller different from the inverter, the controller being for controlling at least one of a friction braking device and the electric drive and being connected to the inverter, the method comprising:
detecting an actual rpm of the electric drive by the inverter;
ascertaining an rpm limit on a basis of a target rpm specified for a wheel configured to be driven by the electric drive via the controller;
determining an adjusted rpm limit as a function of the rpm limit and the actual rpm via the controller; and,
operating the inverter with a reduced torque based on the adjusted rpm limit.

2. The method of claim 1, wherein the reduced torque is determined depending on a difference between the adjusted rpm limit and the actual rpm of the electric drive.

3. The method of claim 1, wherein the adjusted rpm limit is determined such that the actual rpm of the inverter corresponds to the rpm limit.

4. The method of claim 1, wherein said ascertaining the rpm limit is carried out while taking into account an actual wheel rpm related to the wheel and an actual vehicle speed of the vehicle.

5. The method of claim 4, wherein the adjusted rpm limit is determined such that a speed of the wheel of the vehicle that slips more than another wheel corresponds to the target rpm.

6. The method of claim 1, wherein the reduced torque is a driving torque or a braking torque.

7. The method of claim 1 further comprising transmitting the reduced torque from the inverter to a friction brake controller.

8. The method of claim 1, wherein the controller is a friction brake controller or a drive controller.

9. The method of claim 1, wherein the vehicle is a commercial vehicle.

10. An inverter for an electric drive of a vehicle, wherein the inverter is configured to carry out the method of claim 1.

11. The inverter of claim 10, wherein the vehicle is a commercial vehicle.

12. An electric drive comprising the inverter of claim 10.

13. A vehicle comprising the inverter of claim 10.

14. A vehicle comprising the electric drive of claim 12.

15. The vehicle of claim 13, wherein the vehicle is a commercial vehicle.

16. The vehicle of claim 14, wherein the vehicle is a commercial vehicle.

17. A computer program stored on a non-transitory computer readable medium, the computer program comprising:
commands configured, when executed by a computer, to cause the computer to:
detect an actual rpm of an electric drive by an inverter;
ascertain an rpm limit on a basis of a target rpm specified for a wheel configured to be driven by the electric drive via a controller;
determine an adjusted rpm limit as a function of the rpm limit and the actual rpm via the controller; and,
operate the inverter with a reduced torque based on the adjusted rpm limit.

18. A non-transitory computer readable medium having the computer program of claim 17 stored thereon.
